(19) United States
(12) Patent Application Publication
(10) Pub. No.: US 2021/0349366 A1
(43) Pub. Date: Nov. 11, 2021

(54) PRIVACY LENSES FOR CAMERAS

(71) Applicant: Hewlett-Packard Development Company, L.P., Spring, TX (US)

(72) Inventors: Jian Ming Chen, Taipei (TW); Chia Wei Ting, Taipei (TW); Jung Chun Chen, Taipei (TW)

(73) Assignee: Hewlett-Packard Development Company, L.P., Spring, TX (US)

(21) Appl. No.: 17/283,631

(22) PCT Filed: Dec. 5, 2018
(86) PCT No.: PCT/US2018/063994

§ 371 Date: Apr. 8, 2021

(51) Int. Cl. G02F 1/157; H04N 5/225

(52) U.S. Cl. CPC G02F 1/157; G06F 21/83; H04N 5/2254

(57) ABSTRACT

In example implementations, an apparatus is provided. The apparatus includes a light source, a light guide coupled to the light source, and a camera having a privacy lens coupled to the light guide. The light source is to emit light. The privacy lens receives light from the light source via the light guide to activate the privacy lens. A housing of an electronic device is to enclose the light source, the light guide, and the camera having the privacy lens.

### BACKGROUND

Electronic devices are becoming more multi-functional. For example, computers, mobile devices, and the like may be used to execute software applications. Electronic devices are also adding cameras to add functionality and convenience. The cameras on electronic devices can be used to take pictures, capture video, conduct video conferences, and the like. The camera on an electronic device may be a red, green, blue (RGB) camera.

### BRIEF DESCRIPTION OF THE DRAWINGS

FIG. 1 illustrates an example electronic device with a privacy lens of the present disclosure;

FIG. 2 illustrates an example assembly of the privacy lens in a housing of the electronic device of the present disclosure when a light source is turned off;

FIG. 3 illustrates an example assembly of the privacy lens in the housing of the electronic device of the present disclosure when the light source is turned on;

FIG. 4 is a block diagram of an electronic device with a privacy lens of the present disclosure; and

FIG. 5 is a block diagram of an example non-transitory computer readable storage medium storing instructions executed by a processor to activate a privacy lens of an electronic device.

### DETAILED DESCRIPTION

Examples described herein provide privacy lenses for cameras. As discussed above, electronic devices can have cameras that can add to the functionality of an electronic device. However, cameras can be hacked by other users to spy unknowingly on users of the electronic devices. As a result, cameras on electronic devices can pose a security risk for users.

One design may use a shutter on the camera. The shutter may be a mechanical device that can be moved over the camera to block a view of the camera. For example, a tab may be slid left and right away from the camera and over the camera. However, mechanical shutters can be inconvenient to use and may break or malfunction over time.

Examples herein provide a privacy lens that can be activated by a light source. The privacy lens may be coated with a chemical that may react with light to turn black. As a result, the camera may be prevented from capturing images. When the light source is turned off, the chemical may gradually turn transparent again to allow the camera to capture images.

In an example, the light source may be focused through a light guide to ensure that the light does not leak out of the housing of the electronic device. Additional shades may be deployed to ensure that the light emitted from the light source is focused on the privacy lens to provide an enjoyable user experience when the privacy lens is activated.

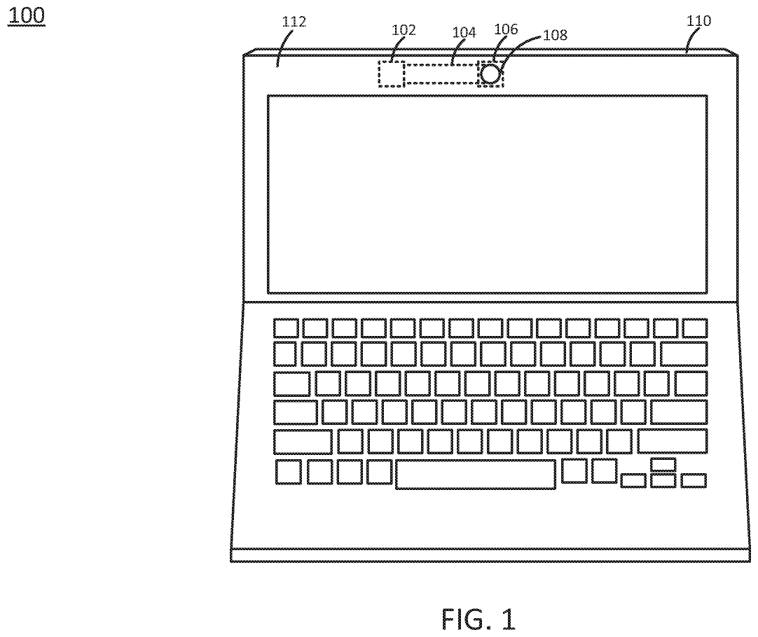

FIG. 1 illustrates an example electronic device 100 with a privacy lens 108 of the present disclosure. The electronic device 100 may be any type of electronic device that may have a built in camera. For example, the electronic device 100 may be a laptop computer, a tablet computer, a monitor, an all-in-one computer, and the like.

In one example, the electronic device 100 may include a light source 102, a light guide 104, and a camera 106. The camera 106 may include a privacy lens 108. The light source 102, the light guide 104, and a portion of the camera 106 are illustrated in dashed lines as they are enclosed in a housing 110 of the electronic device 100. The light source 102, the light guide 104, and the camera 106 may be located along a bezel 112 of the housing 110. For example, the bezel 112 may be an edge or outer perimeter of the housing 110.

The light source 102 may be a light emitting diode (LED) that emits an ultra violet (UV) light. The light source 102 may include a single LED or a plurality of LEDs. In one example, the light source 102 may be coupled to a light guide 104. The light guide 104 may channel a light emitted by the light source 102 towards the privacy lens 108. The light guide 104 may be a solid transparent material that provides total internal reflection (TIR). For example, the solid transparent material may be a transparent plastic material, glass, or optical material that is shaped to provide TIR. The light emitted from the light source 102 may be reflected internally in the light guide 104 until the light reaches the privacy lens 108.

In one example, the light guide 104 may be a hollowed reflective material or may be any type of material that may be lined with a reflective material on an inside surface of the light guide 104. For example, the light guide 104 may have a mirrored interior surface that may reflect the light emitted from the light source 102 towards the privacy lens 108.

In one example, the camera 106 may be any type of camera that can capture images or videos. The camera 106 may be a red, green, blue (RGB) camera. The camera 106 may include the privacy lens 108. The privacy lens 108 may be fabricated to change from transparent to opaque when in contact with the light emitted from the light source 102.

In one example, the privacy lens 108 may include a plastic lens that is coated with a layer of an organic photochromic material coated on the plastic lens. In one example, the organic photochromic material may be coated on the plastic lens to a thickness of approximately 100 microns (μm) to 200 μm. In one example, the organic photochromic material may be applied to a thickness of approximately 150 μm. The organic photochromic material may include oxazines, naphthopyrones, and the like.

The organic photochromic material may undergo a redox reaction when contacted with light (e.g., UV light). When contacted with light, the organic photochromic material may change from a transparent appearance to a black or opaque appearance. For example, another photochromic material may include silver chloride (AgCl). Silver chloride may be composed of sliver ions (Ag+) and chloride ions (Cl−). In the presence of UV light the Ag+ and Cl− ions may form a silver chloride atom that blocks light. When the UV light is removed, the silver chloride atoms may dissociate back into Ag+ and Cl− ions that allow light to pass through.

Thus, the privacy lens 108 may use light emitted from the light source 102 enable or disable a privacy mode. For example, when a user wants to enable a privacy mode, the light source 102 may be activated to cause the organic photochromic material to undergo a redox reaction and turn the privacy lens 108 black. Thus, even if someone were to hack the camera 106, the hacker would be unable to see anything through the privacy lens 108 when the privacy mode is enabled.

When the user is ready to use the camera 106, the user may disable the privacy mode and turn off the light source 102. The organic photochromic material may convert back into a transparent appearance and allow the camera 106 to see through the privacy lens 108. As a result, the camera 106 may capture images and/or video.

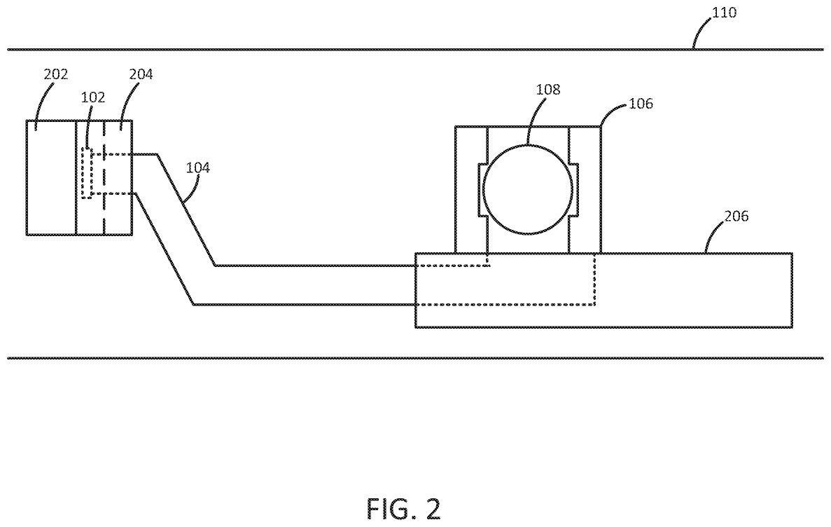

FIG. 2 illustrates an example assembly of the privacy lens 108 in the housing 110 of the electronic device 100. FIG. 2 illustrates an example when the privacy lens 108 is turned off. In other words, the privacy lens 108 may appear transparent and allow the camera 106 to be used.

In one example, the electronic device 100 may include a first shade component over the light source 102. The first shade component may include a piece of foil 202 and a sponge 204. The piece of foil 202 may reflect light emitted by the light source 102 back inside of the housing 110. The sponge 204 may be located over the foil 202 to absorb any light that may leak around the foil 202. The foil 202 and the sponge 204 may be sized to be larger than the light source 102.

In one example, the electronic device 100 may include a second shade component 206. The second shade component 206 may be located over a portion of the light guide 104. In one example, the portion of the light guide 104 over which the second shade component 206 is located may be a light exiting portion that is nearest the privacy lens 108. The second shade component 206 may be a Mylar material to prevent light exiting the light guide 104 from being directed towards a user looking at the camera 106 and the privacy lens 108.

FIG. 2 illustrates how the light guide 104 may be shaped to focus light emitted from light source 102 towards the privacy lens 108. For example, in some instances, the light source 102 may not be positioned next to the privacy lens 108 due to space constraints within the housing 110. Thus, the light guide 104 may be shaped and sized to allow the light source 102 to be located anywhere in the housing 110, while still providing the light onto the privacy lens 108.

The first shade component (e.g., the piece of foil 202 and the sponge 204) and the second shade component 206 may be used to prevent light emitted by the light source 102 from leaking out of the housing 110. For example, without the first shade component and the second shade component 206, light emitted from the light source 102 may leak out of the housing 110 and around the edges of a display and/or the edges around the privacy lens 108. This may be distracting to the user.

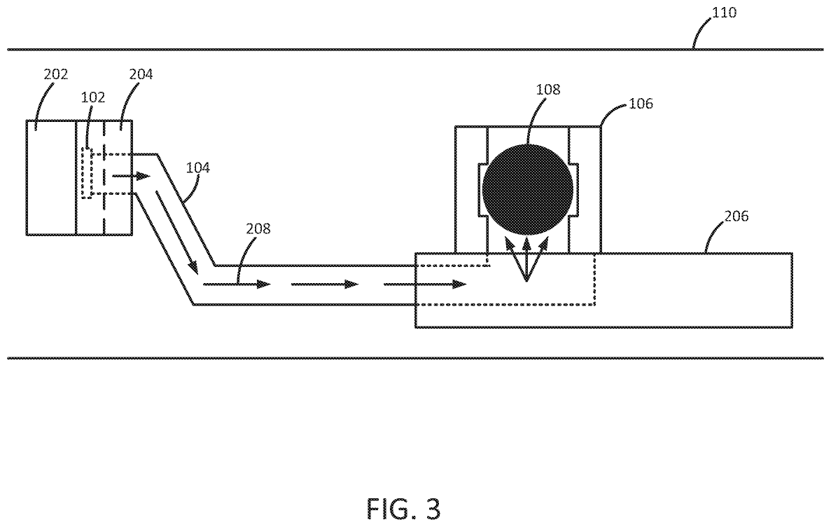

As noted above, FIG. 2 illustrates an example where the privacy mode is disabled and the light source 102 is turned off. As a result, the privacy lens 108 appears clear or transparent. In FIG. 3, the privacy mode may be enabled and the light source 102 may be turned on. As shown in FIG. 3, light rays 208 emitted by the light source 102 may be carried by the light guide 104. The light rays 208 may be UV light rays emitted from a UV LED that is the light source 102.

The light rays 208 may travel within the light guide 104 until they reach an exit that is focused at the privacy lens 108. When the light rays 208 exit the light guide 104, the light rays 208 may cause a redox reaction with a layer of the organic photochromic material coated on the privacy lens 108. As a result, the organic photochromic material may turn black or opaque as shown in FIG. 3. While the light rays 208 are in contact with the privacy lens 108, the privacy lens 108 may appear black and prevent the camera 106 from capturing any images through the privacy lens 108.

When the user wants to use the camera 106 again, the privacy mode can be disabled and the light source 102 may be turned off. When the light source 102 is turned off, the light rays 208 may be removed from the light guide 104 and prevented from contacting the privacy lens 108. The layer of organic photochromic material on the privacy lens 108 may return to a transparent state and the privacy lens 108 may appear clear again as shown in FIG. 2.

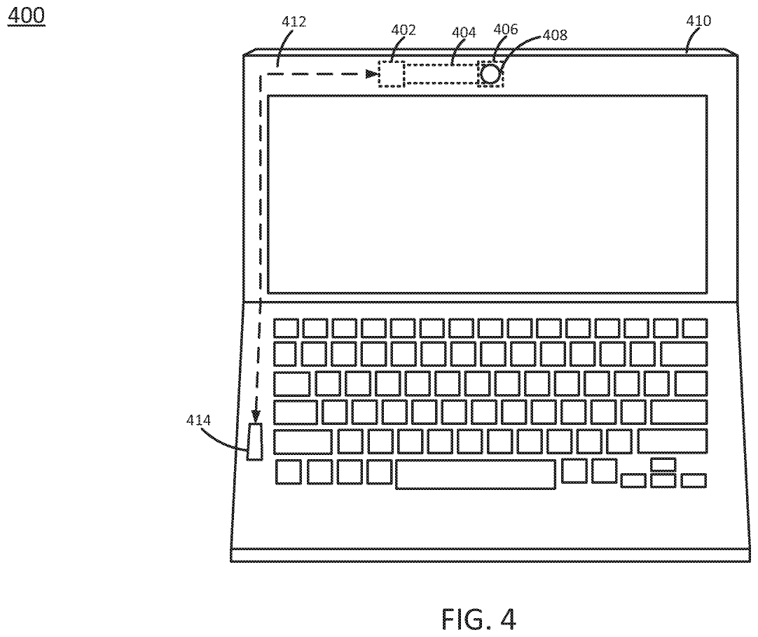

FIG. 4 illustrates another example of an electronic device 400 with a privacy lens 408. The electronic device 400 may include a light source 402, a light guide 404, and a camera 406 similar to the electronic device 100. The camera 406 may include the privacy lens 408. The light source 402, the light guide 404, and a portion of the camera 406 are illustrated in dashed lines as they are enclosed in a housing 410 of the electronic device 400. The light source 402, the light guide 404, and the camera 406 may be located along a bezel 412 of the housing 410. For example, the bezel 412 may be an edge or outer perimeter of the housing 410. The light source 402, the light guide 404, the camera 406, and the privacy lens 408 may be similar to, and operate in a similar fashion as, the light source 102, the light guide 404, the camera 106, and the privacy lens 108 of the electronic device 100.

In one example, the electronic device 400 may include a privacy activation button 414. The privacy activation button 414 may be communicatively coupled to the light source 402 inside of the housing 410, as shown by dashed lines. In one example, when the privacy activation button 414 is pressed while the light source 402 is turned off, the privacy activation button 414 may send a signal to turn on the light source 402 and enable a privacy mode. When the privacy activation button 414 is pressed while the light source 402 is turned on, the privacy activation button 414 may send a signal to turn off the light source 402 and disable the privacy mode.

In one example, the privacy activation button 414 may be coupled to a processor of the electronic device 400. Pressing the privacy activation button 414 may send a signal to the processor to enable or disable a privacy mode. Based on a current state of the light source 402, the processor may decipher the signal to enable or disable the privacy mode. The processor may then control operation of the light source 402 in accordance with the deciphered signal.

Although the privacy activation button 414 is illustrated as a physical button on the housing 410 of the electronic device 400 in FIG. 4, it should be noted that the privacy activation button 414 may also be deployed as a graphical user interface (GUI) button. For example, the privacy activation button 414 may be a button that is displayed in the GUI. The user may select the privacy activation button 414 via a selection made with an external input device (e.g., a mouse or a keyboard). In another example, the user may select the privacy activation button 414 in the GUI by touching the button if the display is a touch screen display.

Thus, the electronic device of the present disclosure may provide a privacy lens that does not use a physical shutter or mechanical device. The privacy lens of the present disclosure may use a low powered light source that does not consume large amounts of power, large amounts of space in the overall design of the electronic device, and provides on/off control of a privacy mode for the camera.

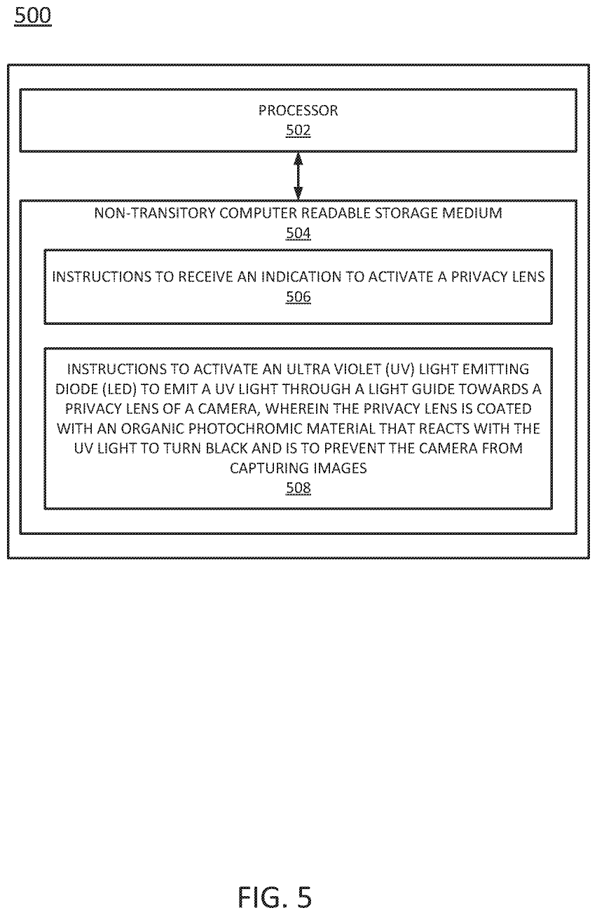

FIG. 5 illustrates an example of an apparatus 500. In an example, the apparatus 500 may be the electronic device 100 or the electronic device 400. In an example, the apparatus 500 may include a processor 502 and a non-transitory computer readable storage medium 504. The non-transitory computer readable storage medium 504 may include instructions 506 and 508 that, when executed by the processor 502, cause the processor 502 to perform various functions.

In an example, the instructions 506 may include instructions to receive an indication to activate a privacy lens. The instructions 508 may include instructions to activate an ultra violet (UV) light emitted diode (LED) to emit a UV light through a light guide towards a privacy lens of a camera, wherein the privacy lens is coated with an organic photochromic material that reacts with the UV light to turn black and is to prevent the camera from capturing images.

In one example, the instructions may also include instructions to receive an indication to deactivate the privacy lens and instructions to deactivate the UV LED to stop UV light from being emitted through the light guide to the privacy lens of a camera, wherein the organic photochromic material on the privacy lens is to turn transparent to allow the camera to capture images. For example, a user may want to use a camera on an electronic

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

1. An electronic device, comprising:
a light source to emit a light;
a light guide coupled to the light source;
a camera having a privacy lens coupled to the light guide to receive light from the light source via the light guide to activate the privacy lens; and
a housing to enclose the light source, the light guide, and the camera having the privacy lens.

2. The electronic device of claim 1, wherein the light source comprises an ultra violet light source.

3. The electronic device of claim 1, wherein the light guide comprises a solid transparent material that provides total internal reflection.

4. The electronic device of claim 1, wherein the light guide comprises a hollow material that has an interior lined with a reflective material.

5. The electronic device of claim 1, wherein the privacy lens comprises:
a plastic lens; and
an organic photochromic material coated on the plastic lens, wherein the organic photochromic material reacts when contacted with light.

6. The electronic device of claim 1, wherein the light source, the light guide, and the privacy lens are located along a bezel of the housing.

7. An electronic device, comprising:
a light emitting diode (LED) to emit a light;
a light guide coupled to the LED;
a camera having a privacy lens coupled to the light guide to receive light from the LED via the light guide to activate the privacy lens; and
a privacy activation button coupled to the LED, wherein the privacy activation button is to power on the LED to emit the light to activate the privacy lens when pressed.

8. The electronic device of claim 7, wherein the LED comprises an ultra violet LED.

9. The electronic device of claim 7, wherein the light guide comprises a transparent plastic material.

10. The electronic device of claim 7, further comprising:
a first shade component over the LED; and
a second shade component around a portion of the light guide.

11. The electronic device of claim 10, wherein the first shade component comprises:
a piece of foil to cover the LED; and
a sponge to absorb any of the light that is emitted around the piece of foil.

12. The electronic device of claim 10, wherein the second shade component comprises a Mylar material.

13. The electronic device of claim 7, wherein the privacy lens comprises:
a plastic lens; and
a layer of oxazines or napthopyrones having a thickness of at least 150 microns.

14. A non-transitory computer readable storage medium encoded with instructions executable by a processor, the non-transitory computer-readable storage medium comprising:
instructions to receive an indication to activate a privacy lens; and
instructions to activate an ultra violet (UV) light emitted diode (LED) to emit a UV light through a light guide towards a privacy lens of a camera, wherein the privacy lens is coated with an organic photochromic material that reacts with the UV light to turn black and is to prevent the camera from capturing images.

15. The non-transitory computer readable storage medium of claim 14, further comprising:
instructions to receive an indication to deactivate the privacy lens; and
instructions to deactivate the UV LED to stop UV light from being emitted through the light guide to the privacy lens of a camera, wherein the organic photochromic material on the privacy lens is to turn transparent to allow the camera to capture images.
